(19) United States
(12) Patent Application Publication
(10) Pub. No.: US 2025/0206978 A1
(43) Pub. Date: Jun. 26, 2025

(54) COATING COMPOSITION AND COATED ARTICLE

(71) Applicant: AGC Inc., Tokyo (JP)

(72) Inventors: Seiya URANO, Tokyo (JP); Shuhei OCHI, Tokyo (JP)

(73) Assignee: AGC Inc., Tokyo (JP)

(21) Appl. No.: 19/077,648

(22) Filed: Mar. 12, 2025

Related U.S. Application Data
(63) Continuation of application No. PCT/JP2023/035198, filed on Sep. 27, 2023.

(30) Foreign Application Priority Data
Oct. 6, 2022 (JP) 2022-161676

(51) Int. Cl. C09D 133/10; C04B 41/48; C09D 5/02; C09D 7/20; C09D 127/12

(52) U.S. Cl. CPC C09D 133/10; C04B 41/483; C04B 41/4842; C09D 5/022; C09D 7/20; C09D 127/12

(57) ABSTRACT

Provided are a coating composition having good film forming properties in low temperature environments and capable of forming coating films with good adhesion to concrete substrates, and a coated article. The coating composition of the present invention contains a fluoropolymer, a (meth)acrylic polymer and water, wherein a particle size of the (meth)acrylic polymer in the coating composition is 150 nm or more, wherein a glass transition temperature of the (meth)acrylic polymer is 40° C. or lower, wherein each of minimum film forming temperatures of the fluoropolymer and the (meth)acrylic polymer is 50° C. or lower, wherein the absolute value of a difference between the minimum film forming temperatures of the fluoropolymer and the (meth)acrylic polymer is 20° C. or less, and wherein the absolute value of a difference between the particle sizes of the fluoropolymer and the (meth)acrylic polymer is 35 nm or less. The minimum film forming temperature of the fluoropolymer may be 60° C. or lower.

### TECHNICAL FIELD

The present invention relates to a coating composition and a coated article.

### BACKGROUND ART

Coating compositions containing fluoropolymers are capable of forming highly weather-resistant coating films. As such a coating composition, Patent Document 1 discloses a coating material containing a fluoropolymer and a (meth)acrylic polymer.

### PRIOR ART DOCUMENTS

### Patent Documents

Patent Document 1: WO2020/090749

### DISCLOSURE OF INVENTION

### Technical Problem

Fluoropolymer-containing coating compositions are used in a variety of applications and environments and, for example, may be used to form coating films in low temperature environments.

Further, coating films formed from fluoropolymer-containing coating compositions may be arranged on substrates of concrete materials (hereinafter also referred to as concrete substrates) in order to impart weather resistance, water resistance and the like to the concrete substrates.

The present inventors have assessed the coating composition containing a fluoropolymer and a (meth)acrylic polymer as disclosed in Patent Document 1 and found that the coating composition has room for improvements in at least one of the film forming properties in low temperature environments and the adhesion of coating films formed therefrom to concrete substrates.

The present invention has been made in view of the above-mentioned problem. It is an object of the present invention to provide a coating composition having good film forming properties in low temperature environments and capable of forming coating films with good adhesion to concrete substrates, and to provide a coated article.

### Solution to Problem

As a result of intensive studies made to solve the above-mentioned problems, the present inventors have found that a coating composition containing a fluoropolymer, a (meth)acrylic polymer and water can achieve desired effects when the particle size of the (meth)acrylic polymer is 150 nm or more; the glass transition temperature of the (meth)acrylic polymer is 40° C. or lower; the minimum film forming temperatures of the fluoropolymer and the (meth)acrylic polymer are 50° C. or lower; the absolute value of a difference between the minimum film forming temperatures of the fluoropolymer and the (meth)acrylic polymer is 20° C. or less; and the absolute value of a difference between the particle sizes of the fluoropolymer and the (meth)acrylic polymer is 35 nm or less, and thus have accomplished the present invention.

Further, the present inventors have found that the above-mentioned coating composition can achieve desired effects even when the minimum film forming temperature of the fluoropolymer is 60° C. or lower.

Namely, the present inventors have found the following solutions to the above-mentioned problems.

[1]A coating composition comprising a fluoropolymer, a (meth)acrylic polymer and water,
wherein a particle size of the (meth)acrylic polymer in the coating composition is 150 nm or more,
wherein a glass transition temperature of the (meth)acrylic polymer is 40° C. or lower,
wherein each of minimum film forming temperatures of the fluoropolymer and the (meth)acrylic polymer is 50° C. or lower,
wherein the absolute value of a difference between the minimum film forming temperatures of the fluoropolymer and the (meth)acrylic polymer is 20° C. or less, and
wherein the absolute value of a difference between the particle sizes of the fluoropolymer and the (meth)acrylic polymer is 35 nm or less.
   [2] The coating composition according to [1], wherein the fluoropolymer has units based on CF₂═CFCl.
   [3] The coating composition according to [1] or [2], wherein the coating composition has a viscosity of 200 mPa·s or higher at 25° C.
   [4] The coating composition according to any one of [1] to [3], further comprising a film forming aid.
   [5] The coating composition according to any one of [1] to [4], wherein the mass ratio of the content of the (meth)acrylic polymer to the content of the fluoropolymer is from 10/90 to 60/40.
   [6]A coated article comprising a substrate and a coating film formed from the coating composition as defined in any one of [1] to [5] on the substrate,
wherein the substrate is made of a concrete material.
   [7]A coating composition comprising a fluoropolymer, a (meth)acrylic polymer and water, wherein a particle size of the (meth)acrylic polymer in the coating composition is 150 nm or more; wherein a glass transition temperature of the (meth)acrylic polymer is 40° C. or lower; wherein a minimum film forming temperature of the fluoropolymer is 60° C. or lower; wherein a minimum film forming temperature of the (meth)acrylic polymer is 50° C. or lower; wherein the absolute value of a difference between the minimum film forming temperature of the fluoropolymer and the minimum film forming temperature of the (meth)acrylic polymer is 20° C. or less; and wherein the absolute value of a difference between the particle sizes of the fluoropolymer and the (meth)acrylic polymer is 35 nm or less.
   [8] The coating composition according to [7], wherein the fluoropolymer has units based on CF₂═CFCl.
   [9] The coating composition according to [7] or [8], wherein the coating composition has a viscosity of 200 mPa·s or higher at 25° C.
   [10] The coating composition according to any one of [7] to [9], further comprising a film forming aid.
   [11] The coating composition according to any one of [7] to [10], wherein the mass ratio of the content of the (meth)acrylic polymer to the content of the fluoropolymer is from 10/90 to 60/40.
   [12]A coated article comprising a substrate and a coating film formed from the coating composition as defined in any one of [7] to [11] on the substrate,
wherein the substrate is made of a concrete material.

### Advantageous Effects of Invention

According to the present invention, it is possible to provide a coating film having good film forming properties in low temperature environments and capable of forming coating films with good adhesion to concrete substrates, and to provide a coated article.

### DESCRIPTION OF EMBODIMENTS

The following terms used in the present invention have the following meanings.

A numerical range expressed using “to” means a range including numerical values described before and after “to” as the lower and upper limits.

A unit is a generic term for an atomic group derived from one molecule of monomer, which is directly formed by polymerization of the monomer, and an atomic group obtained by chemical conversion of a part of the aforementioned atomic group.

The contents (mol %) of respective units to all the units in a polymer can be determined from the amounts of respective components used for production of the polymer.

“(Meth)acrylic” is a generic term for “acrylic” and “methacrylic”. An “(meth)acrylate” is a generic name for “acrylates” and “methacrylates”.

A hydrolyzable silyl group means a group that can be hydrolyzed to form a silanol group.

An acid value and a hydroxy value refer to values each measured according to the method defined in JIS K0070-3(1992).

A glass transition temperature (Tg) means a midpoint glass transition temperature of a polymer as measured by a differential scanning calorimetry (DSC) method.

A minimum film forming temperature (MFT) means a minimum temperature at which a uniform coating film with no cracks is formed by drying a polymer, and can be measured by, for example, a film forming temperature measuring device IMC-1535 (manufactured by Imoto Machinery Co., Ltd.).

A number-average molecular weight (Mn) refers to a value measured by gel permeation chromatography using polystyrene as a standard.

The coating composition of the present invention (hereinafter also referred to as the present coating material) contains a fluoropolymer, a (meth)acrylic polymer and water, wherein the particle size of the (meth)acrylic polymer is 150 nm or more; the Tg of the (meth)acrylic polymer is 40° C. or lower; the MFT of each of the fluoropolymer and the (meth)acrylic polymer is 50° C. or lower; the absolute value of a difference between the MFT of the fluoropolymer and the MFT of the (meth)acrylic polymer is 20° C. or less; and the absolute value of a difference between the particle size of the fluoropolymer and the particle size of the (meth)acrylic polymer is 35 nm or less. The MFT of the fluoropolymer may be 60° C. or lower.

It is estimated that, since the present coating material satisfies the physical properties that: the MFT of each of the fluoropolymer and the (meth)acrylic polymer are 50° C. or lower; the absolute value of the difference between the MFT of the fluoropolymer and the MFT of the (meth)acrylic polymer is 20° C. or less; the absolute value of the difference between the particle sizes of the fluoropolymer and the (meth)acrylic polymer is 35 nm or less; and the particle size of the (meth)acrylic polymer is 150 nm or more, the present coating material achieves improved film forming properties in low temperature environments by the synergistic action of the effects of these physical properties. Here, the MFT of the fluoropolymer may be 60° C. or lower.

It is further estimated that a coating film of the present coating material shows improved adhesion to concrete substrates by the use of the (meth)acrylic polymer with the above-mentioned Tg and particle size.

The fluoropolymer contains fluorine-containing units. The fluorine-containing units are preferably units (hereinafter also referred to as units F1) based on a fluoroolefin.

The fluoroolefin refers to an olefin having one or more hydrogen atoms substituted by fluorine atoms. In the fluoroolefin, one or more of hydrogen atoms not substituted by fluorine atoms may be substituted by chlorine atoms.

Specific examples of the fluoroolefin include CF₂═CF₂, CF₂═CFCl, CF₂═CHF, CH₂═CF₂, CF₂═CFCF₃, CF₂═CHCF₃, CF₃CH═CHF, CF₃CF═CH₂ and monomers represented by CH₂═CX^{f1}(CF₂)ₙ₁Y^{f1} (where X^{f1} and Y^{f1} are each independently a hydrogen atom or a fluorine atom; n1 is an integer of 2 to 10). With a view to achieving high weather resistance of the present coating film, CF₂═CF₂, CH₂═CF₂, CF₂═CFCl, CF₃CH═CHF or CF₃CF═CH₂ is preferred; CF₂═CF₂ or CF₂═CFCl is more preferred; CF₂═CFCl is further more preferred.

Two or more types of fluoroolefins may be used in combination.

In terms of the weather resistance of the present coating film, the content of the units F1 to all the units in the fluoropolymer is preferably 20 to 100 mol %, more preferably 30 to 70 mol %, still more preferably 40 to 60 mol %.

The fluoropolymer may contain units (hereinafter also referred to as units F2) having at least either aliphatic hydrocarbon rings or aromatic rings. The units F2 are preferably units based on a monomer (hereinafter also referred to as a monomer f2) having at least one of an aliphatic hydrocarbon ring and an aromatic ring.

Preferably, the units F2 contain no fluorine.

Specific examples of the aliphatic hydrocarbon ring include: monocyclic aliphatic hydrocarbons such as cyclobutane, cyclopentane, cyclohexane, cycloheptane and cyclooctane; polycyclic aliphatic hydrocarbons such 4-cyclohexylcyclohexane and decahydronaphthalene; norbornane and other aliphatic hydrocarbons having a bridged ring structure such as 1-adamantyl group; and aliphatic hydrocarbons having a spiro ring structure such as spiro[3.4]octyl group or the like.

Specific examples of the aromatic ring include: aromatic hydrocarbon rings such as benzene, toluene, xylene, naphthalene, phenol and benzoic acid; and aromatic heterocyclic rings such as furan, thiophene, pyrrole and pyridine.

The monomer f2 is preferably selected from a vinyl ether, a vinyl ester, an allyl ether, an allyl ester and a (meth)acrylic ester, each having at least one of an aliphatic hydrocarbon ring and an aromatic ring.

Specific examples of the monomer f2 include cyclohexyl (meth)acrylate, cyclohexyl vinyl ether, cyclohexanedimethanol monovinyl ether (CH₂═CHO—CH₂-cycloC₆H₁₀—CH₂OH), CH₂═CHCH₂O—CH₂-cycloC₆H₁₀—CH₂OH, CH₂═CHO—CH₂-cycloC₆H₁₀—CH₂—(OCH₂CH₂)₁₅OH, vinyl benzoate, vinyl tert-butylbenzoate and benzyl (meth)acrylate.

Here, “-cycloC₆H₁₀—” represents a cyclohexylene group, and the bonding sites of “-cycloC₆H₁₀—” are usually 1,4-positions.

The monomer f2 may be a combination of two or more types thereof.

In the case where the fluoropolymer contains units F-2, the content of the units F-2 to all the units in the fluoropolymer is preferably 0.1 to 15 mol %, more preferably 0.5 to 10 mol %, still more preferably 1 to 5 mol %.

The fluoropolymer may contain units (hereinafter also referred to as units F-3) having neither aliphatic hydrocarbon rings nor aromatic rings and having at least either hydroxy groups or carboxy groups. Preferably, the unit F-3 contains no fluorine.

The units F-3 may be units based on a monomer (hereinafter also referred to as a monomer f3) having at least one of a hydroxy group and a carboxy group, and may be units obtained by modifying a fluoropolymer containing units having groups convertible to hydroxy groups or carboxy groups to convert these convertible groups to at least either hydroxy groups or carboxy groups. Examples of such units include those obtained by reacting a fluoropolymer containing hydroxy group-containing units with a polycarboxylic acid or an anhydride thereof etc. to convert all or part of the hydroxy groups to carboxy groups.

The monomer f3 having a hydroxy group may be a vinyl ether, a vinyl ester, an allyl ether, an allyl ester, a (meth)acrylic ester, each having a hydroxy group, an allyl alcohol, or the like. The monomer f3 having a hydroxy group is preferably a vinyl ether in terms of the weather resistance of the present coating film.

Specific examples of the monomer f3 having a hydroxy group include CH₂═CHOCH₂CH₂OH, CH₂═CHCH₂OCH₂CH₂OH, CH₂═CHOCH₂CH₂CH₂CH₂OH and CH₂═CHCH₂OCH₂CH₂CH₂CH₂OH. In terms of copolymerizability with the fluoroolefin, CH₂═CHCH₂OCH₂CH₂OH or CH₂═CHOCH₂CH₂CH₂CH₂OH is preferred.

The monomer f3 having a carboxy group may be an unsaturated carboxylic acid, a (meth)acrylic acid, a monomer obtained by reaction of the above-mentioned hydroxy group-containing monomer with a carboxylic anhydride, or the like.

Specific examples of the monomer f3 include CH₂═CHCOOH, CH(CH₃)═CHCOOH, CH₂═C(CH₃)COOH, HOOCCH═CHCOOH, CH₂═CH(CH₂)ₙ₁₁COOH (where n11 is an integer of 1 to 10) and CH₂═CHO(CH₂)ₙ₁₂OC(O)CH₂CH₂COOH (where n12 is an integer of 1 to 10). In terms of copolymerizability with the fluoroolefin, CH₂═CH(CH₂)ₙ₁₁COOH or CH₂═CHO(CH₂)ₙ₁₂OC(O)CH₂CH₂COOH is preferred.

The monomer f3 may be a combination of two or more types thereof.

In the case where the fluoropolymer contains units F-3, the content of the units F-3 is preferably more than 0 mol % and 30 mol % or less, more preferably 1 to 15 mol %, still more preferably 1.5 to 5 mol %.

The fluoropolymer may contain units (hereinafter also referred to as units F-4) based on a monomer (hereinafter also referred to as a monomer f4) having neither an aliphatic hydrocarbon ring nor an aromatic ring and having no hydroxy group and no carboxy group. Preferably, the unit F-4 contains no fluorine.

The unit F-4 may have a cross-linkable group other than a hydroxy group and a carboxy group. Specific examples of such a group include an amino group, an epoxy group, an oxetanyl group and a hydrolysable silyl group.

The monomer f4 may be at least one selected from the group consisting of an alkene, a vinyl ether, a vinyl ester, an allyl ether, an allyl ester and a (meth)acrylic ester. In terms of the copolymerizability with the fluoroolefin and the weather resistance of the obtainable fluoropolymer, the monomer f4 is preferably at least one of a vinyl ether and a vinyl ester, particularly preferably a vinyl ether.

Specific examples of the monomer f4 include ethylene, propylene, 1-butene, ethyl vinyl ether, tert-butyl vinyl ether, 2-ethylhexyl vinyl ether, vinyl acetate, vinyl pivalate, vinyl neononanoate (product name “VeoVa 9”, manufactured by HEXION INC.), vinyl neodecanoate (product name “VeoVa 10”, manufactured by HEXION INC.) and tert-butyl (meth)acrylate.

The monomer f4 may be a combination of two or more types thereof.

In the case where the fluoropolymer contains units F-4, the content of the units F-4 to all the units in the fluoropolymer is preferably 5 to 60 mol %, more preferably 10 to 50 mol %, still more preferably 45 to 50 mol %.

It is preferred that the fluoropolymer is dispersed in water. In this case, the fluoropolymer is dispersed in the form of particles in the present coating material.

In the present coating material, the particle size of the fluoropolymer is preferably 130 to 190 nm, more preferably 135 to 180 nm, still more preferably 140 to 170 nm. When the particle size of the fluoropolymer is 130 nm or more, good followability to concrete substrates is obtained. When the particle size of the fluoropolymer is 190 nm or less, better adhesion to concrete substrates is obtained.

The particle size of the fluoropolymer in the present coating material is measured by the following method.

First, 10 g of the present coating material is dried at 60° C. for 24 hours to obtain a coating film with a thickness of 50 μm. The obtained coating film is cut in a thickness direction by a microtome such that a cross section of the coating film is exposed.

Next, an observation image of the cross section of the coating film is taken by a scanning electron microscope with an energy dispersive spectrometer (SEM-EDS). By elemental analysis of particles in the observation image, the particles of the fluoropolymer are specified to determine the sizes (equivalent circle diameters) of the fluoropolymer particles. The particle sizes of 100 different particles of the fluoropolymer are measured, and the arithmetic mean of these measured particle sizes is taken as the particle size of the fluoropolymer in the present coating material.

In the case where the number of particles of the fluoropolymer in one observation image is 100 or less, the above analysis is performed on different cross sections of the sample until the number of particles of the fluoropolymer reaches 100.

As the SEM-EDX, JSM-IT700HR (manufactured by JEOL Ltd.) can be used.

The Tg of the fluoropolymer is preferably 0° C. or higher, more preferably 10° C. or higher.

The Tg of the fluoropolymer is preferably 80° C. or lower, more preferably 30° C. or lower.

The MFT of the fluoropolymer is 50° C. or lower, and is preferably 45° C. or lower with a view to achieving better film forming properties in low temperature environments.

The MFT of the fluoropolymer may be 60° C. or lower in terms of the film forming properties.

The lower limit of the MFT of the fluoropolymer is usually 0° C. or higher.

The Mn of the fluoropolymer is preferably 1000 to 1000000.

In the case where the fluoropolymer has a hydroxy value, the hydroxy value of the fluoropolymer is preferably 1 to 80 mgKOH/g, particularly preferably 10 to 30 mgKOH/g.

In the case where the fluoropolymer has an acid value, the acid value of the fluoropolymer is preferably 1 to 80 mgKOH/g, particularly preferably 10 to 30 mgKOH/g.

The fluoropolymer may have either one or both of an acid value and a hydroxy value.

The fluoropolymer may be a combination of two or more types thereof.

The content of the fluoropolymer to the total mass of the present coating material is preferably 10 to 90 mass %, more preferably 15 to 60 mass %, still more preferably 20 to 40 mass %. When the content of the fluoropolymer is 10 mass % or more, the coating film is obtained with higher weather resistance.

The fluoropolymer can be produced by copolymerization of respective monomers in the presence of a solvent and a radical polymerization initiator. As examples of the polymerization method, emulsion polymerization, suspension polymerization and solution polymerization may be mentioned. Preferred is emulsion polymerization. The polymer may be obtained as a dispersion in water by solution polymerization, followed by solvent replacement. The polymerization temperature and the polymerization time can be selected as appropriate.

In the polymerization, a surfactant, a radical polymerization initiator, a chain transfer agent, a chelating agent, a pH adjuster and the like may be used.

The (meth)acrylic polymer is a polymer containing units based on a (meth)acrylate.

The (meth)acrylic polymer may consist only of units based on a (meth)acrylate, or may contain units based on a monomer other than a (meth)acrylate, such as a styrene or (meth)acrylic acid.

The (meth)acrylic polymer may have a cross-linkable group such as a carboxy group, a hydroxy group, an amino group, an epoxy group, an oxetanyl group or a hydrolysable silyl group.

The (meth)acrylic polymer may be a silicone-modified (meth)acrylic polymer.

The (meth)acrylic polymer may have a hindered amine group.

Specific examples of the (meth)acrylate include alkyl (meth)acrylates (such as methyl (meth)acrylate, ethyl (meth)acrylate, butyl (meth)acrylate and 2-ethylhexyl (meth)acrylate), hydroxyalkyl (meth)acrylates (such as hydroxyethyl (meth)acrylate) and glycidyl (meth)acrylate.

The (meth)acrylic polymer may be a commercially available product. Specific examples of the commercially available (meth)acrylic polymer include UWR (registered trademark) E-771SI (manufactured by NIPPON SHOKUBAI CO., LTD.), Polysol (registered trademark) AP-3900, AP-4710N and AP-4765N (all manufactured by Showa Denko K.K.), Acronal 7067 and YJ3031 D AP (both manufactured by BASF), ELASTENE 1500 and 2471 (both manufactured by Dow Inc.), and ZH140 (manufactured by Aqua Union).

In the present coating material, the (meth)acrylic polymer is dispersed in the form of particles.

The particle size of the (meth)acrylic polymer in the present coating material is 150 nm or more. With a view to achieving better film forming properties of the coating material and better adhesion of the coating film to concrete substrates, the particle size of the (meth)acrylic polymer is preferably 150 nm or more, more preferably 155 nm or more.

The particle size of the (meth)acrylic polymer in the present coating material is preferably 200 nm or less, more preferably 190 nm or less.

The particle size of the (meth)acrylic polymer in the present coating material is measured by the same method as the particle size of the fluoropolymer, except that the particles of the (meth)acrylic polymer are specified by elemental analysis to determine the sizes of the (meth)acrylic polymer particles.

The absolute value of the difference between the particle size of the fluoropolymer and the particle size of the (meth)acrylic polymer is 35 nm or less, and is preferably 34 nm or less, more preferably 33 nm or less, with a view to allowing uniform fusion between the polymer particles during the film formation and achieving better film forming properties in low temperature environments.

The lower limit of the absolute value of the difference between the particle size of the fluoropolymer and the particle size of the (meth)acrylic polymer is usually 0 nm or more.

The Tg of the (meth)acrylic polymer is preferably 0° C. or higher, more preferably 30° C. or higher.

The Tg of the (meth)acrylic polymer is 40° C. or lower, and is preferably 39.5° C. or lower with a view to achieving better adhesion to concrete substrates.

In the case where a plurality of Tg values are detected, the lowest one of those detected values is taken as the Tg of the (meth)acrylic polymer.

The MFT of the (meth)acrylic polymer is preferably 10° C. or higher, more preferably 15° C. or higher.

The MFT of the (meth)acrylic polymer is 50° C. or lower, and is preferably 45° C. or lower with a view to achieving better film forming properties in low temperature environments.

The absolute value of the difference between the MFT of the fluoropolymer and the MFT of the (meth)acrylic polymer is 20° C. or less, and is preferably 19° C. or less, more preferably 18° C. or less, with a view to further suppressing distortion of the coating film during the film formation and achieving better film forming properties in low temperature environments.

The lower limit of the absolute value of the difference between the MFT of the fluoropolymer and the MFT of the (meth)acrylic polymer is usually 0° C. or more.

The Mn of the (meth)acrylic polymer is preferably 1000 to 1000000.

The (meth)acrylic polymer may be a combination of two or more types thereof.

The content of the (meth)acrylic polymer to the total mass of the present coating material is preferably 20 to 90 mass %, more preferably 10 to 50 mass %, still more preferably 15 to 30 mass %.

The mass ratio of the content of the (meth)acrylic polymer to the content of the fluoropolymer (content of (meth)acrylic polymer/content of fluoropolymer) is preferably from 10/90 to 60/40 to achieve more excellent effects of the present invention.

The content of water to the total mass of the present coating material is preferably 30 to 60 mass %, more preferably 40 to 50 mass %.

The present coating material preferably contains a film forming aid. The film forming aid serves to improve uniform mixing of the fluoropolymer and the (meth)acrylic polymer in the present coating film and form the present coating film with higher water resistance.

The film forming aid is preferably a compound having a boiling point of 100 to 400° C., more preferably a compound having a boiling point of 130 to 300° C., particularly preferably a compound having a boiling point of 150 to 250° C.

The film forming aid may be, for example, a glycol ether, a glycol ether acetate, an ester etc.

A glycol ether, a glycol ether acetate, an ester etc., having a boiling point in above-mentioned range, is less likely evaporate than water during the formation of the coating film so that it is possible to suppress rapid film formation of the water-based coating material on the substrate. Since the coating film is formed while maintaining uniformity in composition of the fluoropolymer and the (meth)acrylic polymer, the water resistance of the coating film is presumably improved. On the other hand, the above-exemplified compound is less likely to remain in the coating film so that water is not easily absorbed into the coating film, and thus, the water resistance of the coating film is presumably improved.

Specific examples of the film forming aid include: glycol ethers such as diethylene glycol monomethyl ether, diethylene glycol monoethyl ether, diethylene glycol dimethyl ether, diethylene glycol diethyl ether, diethylene glycol dibutyl ether, diethylene glycol monobenzyl ether, dipropylene glycol mono-n-butyl ether, ethylene glycol mono-2-ethylhexyl ether and ethylene glycol monoallyl ether; glycol ether acetates such as ethylene glycol mono-n-butyl ether acetate and diethylene glycol mono-n-butyl ether acetate; esters such as 2,2,4-trimethylpentane-1,3-diol monoisobutyrate (texanol), triacetin, diethyl adipate, diisodecyl adipate, bis(2-butoxyethyl)adipate and dibutyl sebacate.

Two or more types of film forming aids may be used in combination.

The content of the film forming aid to the total mass of the present coating material is preferably 1 to 30 mass %, more preferably 4 to 20 mass %, still more preferably 8 to 18 mass %.

The present coating material may further contain an additive such as a pigment (an inorganic pigment, an organic pigment etc.), a surfactant, a curing agent, a curing aid, a thickener, a dispersant, an antifoaming agent, a light stabilizer, an ultraviolet absorber, a surface conditioner or the like.

The viscosity of the present coating material at 25° C. is preferably 200 mPa·s or higher, more preferably 300 mPa·s or higher, still more preferably 500 mPa·s or higher, and is preferably 10000 mPa·s or lower, more preferably 7000 mPa·s or lower, still more preferably 5000 mPa·s or lower.

The method of measuring the viscosity of the present coating material is as described later in Examples.

The coated article of the present invention has a substrate and a coating film (present coating film) formed from the present coating material on the substrate, wherein the substrate is made of a concrete material. In the present specification, a substrate whose material contains concrete is also referred to as a concrete substrate.

The thickness of the present coating film is preferably 5 to 300 μm, more preferably 10 to 100 μm. The present coating film is improved in durability when the thickness of the present coating film is larger than or equal to the lower limit value. When the thickness of the present coating film is smaller than or equal to the upper limit value, the present coating film is improved in weather resistance.

The coated article can be produced by applying the present coating material to a surface of the substrate and drying the applied coating material into coating film. The present coating material may be applied directly to the surface of the substrate, or may be applied to the surface of the substrate after performing a known surface treatment (such as surface preparation) on the surface of the substrate. A primer layer may be formed on the substrate, followed by applying the present coating material to the primer layer.

The concrete substrate may be cracked depending on the construction method, the usage environment and the like. Cracks in the concrete substrate can be repaired by filling with a repairing material such as an epoxy resin.

The coating film formed from the present coating material shows good adhesion to concrete substrates even when cracks in the concrete materials are repaired with an epoxy resin or the other repairing material, and thus is suitably used for concrete substrates.

The present coating material is also applicable to substrates made of materials other than concrete. Specific examples of such a substrate material include: organic materials such as resins, rubber and wood; inorganic materials such as glass, ceramics and stone; and metal materials such as iron, iron alloys, aluminum and aluminum alloys.

The present coating material can be applied by means of, for example, a brush, a roller, a dipping machine, a spraying machine, or a coating machine such as a roll coater, a die coater, an applicator or a spin coater.

It is preferred to form the present coating film by applying a coating layer of the present coating material and drying the applied coating layer.

The temperature of the drying after the application is preferably 0 to 50° C. The present coating film may be formed by applying and drying a coating layer of the present coating material and thermally curing the coating layer as required. The temperature of the thermal curing is preferably 50 to 200° C. The drying time is generally 30 minutes to 2 weeks. The thermal curing time is generally 1 minute to 24 hours.

### EXAMPLES

Now, the present invention will be described in further detail with reference to Examples. Ex. 1 and Ex. 4 correspond to Examples of the present invention; and Ex. 2, Ex. 3 and Ex. 5 correspond to Comparative Examples. However, it should be understood that the present invention is by no means restricted thereto. In the table below, the amount of each component used is expressed on a mass basis.

### Abbreviations and Details of Components Used

### [Monomers]

CTFE: Chlorotrifluoroethylene
CHVE: Cyclohexyl vinyl ether
CHMVE: Cyclohexane dimethanol monovinyl ether
CM-EOVE: CH₂═CHOCH₂-cycloC₆H₁₀—CH₂O(CH₂CH₂O)ₙH (n=15)
EVE: Ethyl vinyl ether
MMA: Methyl methacrylate
IBA: Isobutyl acrylate

### [Dispersions]

Dispersion F1: Aqueous dispersion with particles of a fluoropolymer (hydroxy value: 13 mgKOH/g) dispersed at a polymer concentration of 50 mass % in water, wherein the fluoropolymer had 50 mol % units based on CTFE, 2.0 mol % units based on CHMVE, 0.3 mol % units based on CM-EOVE, 46.7 mol % units based on EVE and 1.0 mol % units based on CHVE to all the units in the fluoropolymer.

Dispersion F2: Aqueous dispersion with particles of PVDF (polyvinylidene fluoride) dispersed at a polymer concentration of 50 mass % in water.

Dispersion F3: Aqueous dispersion with particles of a fluoropolymer (hydroxy value: 50 mgKOH/g) dispersed at a polymer concentration of 50 mass % in water, wherein the fluoropolymer had 50 mol % units based on CTFE, 10 mol % units based on CHMVE, 0.5 mol % units based on CM-EOVE, 17 mol % units based on EVE and 22.5 mol % units based on CHVE to all the units in the fluoropolymer.

Dispersion A1: Aqueous dispersion UWR (registered trademark) E-771 SI (manufactured by NIPPON SHOKUBAI CO., LTD.) with particles of a (meth)acrylic polymer dispersed at a polymer concentration of 44 mass % in water.

Dispersion A2: Aqueous dispersion with particles of a (meth)acrylic polymer (MFT: 0° C. or lower, SP value: 26.8 (J/cm³)^{1/2}, average particle size: 110 nm) dispersed therein at a polymer concentration of 44 mass %, wherein the (meth)acrylic polymer had 50 mol % units based on MMA and 50 mol % units based on IBA to all the units in the (meth)acrylic polymer.

Dispersion A3: Aqueous dispersion ZH140 (manufactured by Aqua Union) with particles of a (meth)acrylic polymer dispersed at a polymer concentration of 44 mass % in water.

Dispersion A4: Aqueous dispersion #3000 (registered trademark) 3401 MA (manufactured by TAISEI FINE CHEMICAL CO., LTD.) with particles of a (meth)acrylic polymer dispersed at a polymer concentration of 40 mass % in water.

Here, the dispersions F1, F2, F3 and A2 were prepared by known methods.

### Ex. 1

A coating composition 1 was prepared as a water-based paint by mixing the dispersion F1 (50 g), the dispersion A1 (50 g) and a film forming aid (ethylene glycol mono-2-ethylhexyl ether (EHG), boiling point: 229° C.) (10 g).

### Ex. 2 to Ex. 5

Coating compositions 2 to 5 were respectively prepared as water-based paints in the same manner as in Ex. 1, except the types of the dispersions used were changed as shown in Table 1.

### [Particle Size]

The particle sizes of particles of the fluoropolymer and particles of the (meth)acrylic polymer in each coating composition were measured by the above-mentioned method.

### [Viscosity]

The viscosity (unit: mPa·s) of the coating composition at 25° C. was measured by a E-type viscometer (model “TV-35 viscometer TVE-35H”, manufactured by TOKI SANGYO) under the condition of a rotation speed of 50 rpm.

### [Film Forming Properties in Low Temperature Environments]

To a surface of a concrete substrate with a length of 120 mm, a width of 60 mm and a thickness of 15 mm, each of the coating compositions 1 to 5 was applied in such a manner as to obtain a dry film thickness of 40 μm, and then, dried at room temperature (23° C.) for 2 weeks. After the lapse of 2 weeks, the coating film of each coating composition was touched with a finger to evaluate the film forming properties in low temperature environment of 23° C. where no heat was applied during the formation of the coating film. The evaluation was done according to the following criteria. It can be said that the film forming properties in low temperature environments were good when evaluated as A.
A: No sticking of the coating film occurred when touched with a finger.
B: A little sticking of the coating film occurred when touched with a finger.

### [Adhesion]

The adhesion of the coating film to the concrete substrate was evaluated by a cross-cut test (JIS K5600-5-6).

More specifically, cuts were fere formed at spacings of 1 mm to define a lattice pattern of 100 squares in the coated substrate produced in the above evaluation of the film forming properties in low temperature environments.

An adhesive tape was adhered to the coating film and then peeled off from the coating film. Among 100 squares, the number of squares (squares/100 squares) in which separation of the coating film did not occur due to peeling of the adhesive tape was counted. Based on the counted number of squares, the adhesion of the top layer was evaluated according to the following criteria. It can be said that the adhesion of the coating film to the concrete substrate was good when evaluated as A. Here, each numerical value in parentheses in the adhesion evaluation result column of Table 1 means the counted number of squares (number of squares in which separation did not occur)/100.
A: The counted number of squares was more than 95.
B: The counted number of squares was from 70 to 95.
C: The counted number of squares was less than 70.

TABLE 1

| | | Ex. 1 | Ex. 2 | Ex. 3 | Ex. 4 | Ex. 5 |
|---|---|---|---|---|---|---|
| Type of coating composition | | 1 | 2 | 3 | 4 | 5 |
| Fluoropolymer- | F1 (g) | 50 | 50 | | | |
| containing | F2 (g) | | | 50 | | |
| dispersion | F3 (g) | | | | 50 | 50 |
| (Meth)acrylic | A1 (g) | 50 | | | | |
| polymer- | A2 (g) | | 50 | 50 | | |
| containing | A3 (g) | | | | 50 | |
| dispersion | A4 (g) | | | | | 50 |
| Film forming aid | EHG (g) | 10 | 10 | 10 | 10 | 10 |
| Tg (° C.) of fluoropolymer | | 20 | 20 | 15 | 38 | 38 |
| Tg (C) of (meth)acrylic | | 39.2 | −10 | −10 | 37.5 | 85 |
| polymer | | | | | | |
| MFT (° C.) of fluoropolymer | | 28 | 28 | 27 | 55 | 55 |
| MFT (° C.) of (meth)acrylic | | 45 | 0 or | 0 or | 41.5 | 80 |
| polymer | | | lower | lower | | |
| Absolute value (° C.) of | | 17 | 28 or | 27 or | 13.5 | 25 |
| difference in MFT | | | more | more | | |
| Particle size (nm) of | | 150 | 150 | 210 | 151 | 151 |
| fluoropolymer | | | | | | |
| Particle size (nm) of | | 183 | 110 | 110 | 165 | 400 |
| (meth)acrylic polymer | | | | | | |
| Absolute value (nm) of | | 33 | 40 | 100 | 14 | 249 |
| difference in particle size | | | | | | |
| Viscosity (mPa · s) of coating | | 800 | 1000 | 1000 | 1200 | 2000 |
| composition at 25° C. | | | | | | |
| Evaluation | Film forming | A | A | B | A | B |
| results | properties in low | | | | | |
| | temperature | | | | | |
| | environments | | | | | |
| | Adhesion | A | B | C | A | C |
| | | (100/100) | (90/100) | (0/100) | (96/100) | (0/100) |

As shown in Table 1, it has been confirmed that the coating composition of the present invention has good film forming properties in low temperature environments and is capable of forming coating films with good adhesion to concrete substrates (Ex. 1 and Ex. 4).

This application is a continuation of PCT Application No. PCT/JP2023/035198, filed on Sep. 27, 2023, which is based upon and claims the benefit of priority from Japanese Patent Application No. 2022-161676 filed on Oct. 6, 2022. The contents of those applications are incorporated herein by reference in their entireties.

What is claimed is:

1. A coating composition comprising a fluoropolymer, a (meth)acrylic polymer and water,
wherein a particle size of the (meth)acrylic polymer in the coating composition is 150 nm or more,
wherein a glass transition temperature of the (meth)acrylic polymer is 40° C. or lower,
wherein each of minimum film forming temperatures of the fluoropolymer and the (meth)acrylic polymer is 50° C. or lower,
wherein the absolute value of a difference between the minimum film forming temperatures of the fluoropolymer and the (meth)acrylic polymer is 20° C. or less, and
wherein the absolute value of a difference between the particle sizes of the fluoropolymer and the (meth)acrylic polymer is 35 nm or less.

2. The coating composition according to claim 1, wherein the fluoropolymer has units based on CF₂═CFCl.

3. The coating composition according to claim 1, wherein the coating composition has a viscosity of 200 mPa·s or higher at 25° C.

4. The coating composition according to claim 1, further comprising a film forming aid.

5. The coating composition according to claim 1, wherein the mass ratio of the content of the (meth)acrylic polymer to the content of the fluoropolymer is from 10/90 to 60/40.

6. A coated article comprising a substrate and a coating film formed from the coating composition as defined in claim 1 on the substrate,
wherein the substrate is made of a concrete material.

7. A coating composition comprising a fluoropolymer, a (meth)acrylic polymer and water,
wherein a particle size of the (meth)acrylic polymer in the coating composition is 150 nm or more,
wherein a glass transition temperature of the (meth)acrylic polymer is 40° C. or lower,
wherein a minimum film forming temperature of the fluoropolymer is 60° C. or lower,
wherein a minimum film forming temperature of the (meth)acrylic polymer is 50° C. or lower,
wherein the absolute value of a difference between the minimum film forming temperature of the fluoropolymer and the minimum film forming temperature of the (meth)acrylic polymer is 20° C. or less, and
wherein the absolute value of a difference between the particle size of the fluoropolymer and the particle size of the (meth)acrylic polymer is 35 nm or less.

8. The coating composition according to claim 7, wherein the fluoropolymer has units based on CF₂═CFCl.

9. The coating composition according to claim 7, wherein the coating composition has a viscosity of 200 mPa·s or higher at 25° C.

10. The coating composition according to claim 7, further comprising a film forming aid.

11. The coating composition according to claim 7, wherein the mass ratio of the content of the (meth)acrylic polymer to the content of the fluoropolymer is from 10/90 to 60/40.

12. A coated article comprising a substrate and a coating film formed from the coating composition as defined in claim 7 on the substrate,
wherein the substrate is made of a concrete material.
